(19) United States
(12) Patent Application Publication
(10) Pub. No.: US 2019/0114022 A1
(43) Pub. Date: Apr. 18, 2019

(54) MOBILE TERMINAL CAPABLE OF EASILY CAPTURING IMAGE AND IMAGE CAPTURING METHOD

(71) Applicant: HiDeep Inc., Seongnam-si, Gyeonggi-do (KR)

(72) Inventors: Se Yeob KIM, Seongnam-si (KR); Yun Joung KIM, Seongnam-si (KR)

(73) Assignee: HiDeep Inc., Seongnam-si, Gyeonggi-do (KR)

(21) Appl. No.: 16/087,460

(22) PCT Filed: Mar. 20, 2017
(86) PCT No.: PCT/KR2017/002927

§ 371 Date: Sep. 21, 2018

(30) Foreign Application Priority Data
Mar. 24, 2016 (KR) 10-2016-0035119

(51) Int. Cl. G06F 3/041; G06F 3/044; H04N 5/232; G06F 3/0488; G06F 3/0484

(52) U.S. Cl. CPC G06F 3/0416; G06F 3/044; G06F 2203/04104; G06F 3/0488; G06F 3/0484; H04N 5/232

(57) ABSTRACT

An image capturing method that includes: detecting a pressure touch with a pressure having a magnitude greater than a predetermined magnitude on a touch screen; determining an initial touch position and a final touch position of the pressure touch; setting an area defined by the initial touch position and the final touch position as a capture area; and obtaining an image displayed in the set capture area. As a result, it is possible to easily capture images displayed on the mobile terminal in various ways.

### TECHNICAL FIELD

The present disclosure relates to a mobile terminal capable of easily capturing images and an image capturing method and more particularly to a mobile terminal capable of easily capturing images on the basis of a touch having a pressure, and an image capturing method.

### BACKGROUND ART

Various kinds of input devices for operating a computing system, such as a button, key, joystick, touch screen, etc., are being developed and used. The touch screen has a variety of advantages, e.g., ease of operation, miniaturization of products and simplification of the manufacturing process, so that the most attention is paid to the touch screen.

The touch screen can constitute a touch surface of a touch input device including a touch sensor panel. The touch sensor panel is attached to the front side of the touch screen, and then covers the touch screen. A user is able to operate the corresponding device by touching the touch screen with his/her finger. The corresponding device detects whether or not the touch of the user occurs and the position of the touch, performs operations, and performs operations corresponding to a user operation.

Most devices (e.g., a mobile terminal, PDA, etc.) employing the touch screen determines whether a user touches or not and a touch position, and then performs a specific operation. Specifically, when the user touches an area where an application is displayed, the device detects the position where the touch has occurred, and executes, drives, or terminates the application. Each device may also execute the application on the basis of a touch time, the number of touches, or patterns. For example, an object which is displayed by a long touch, a double touch, a multi touch, etc., can be performed in various ways.

However, in the above-mentioned conventional touch control method, since a specific operation is performed based on the touch position, patterns, and touch time, controllable operations are limited. With the current viewpoint that the functions of various devices are being integrated and are being gradually diversified, there is a requirement for a new touch method departing from the conventional touch control method.

However, it is not easy to not only reproduce the conventional touch control method as it is but also implement a new touch method at the same time. Also, it is difficult to detect the conventional touch method and the new touch method at the same time without depending on time division.

### DISCLOSURE

### Technical Problem

The present invention is designed in consideration of the above problems. The object of the present invention is to provide a mobile terminal capable of executing various applications by using a new touch type based on a touch pressure. Particularly, the object of the present invention is to provide a mobile terminal capable of easily capturing in various ways images displayed on the mobile terminal, and an image capturing method.

### Technical Solution

One embodiment is an image capturing method that includes: detecting a pressure touch with a pressure having a magnitude greater than a predetermined magnitude on a touch screen; determining an initial touch position and a final touch position of the pressure touch; setting an area defined by the initial touch position and the final touch position as a capture area; and obtaining an image displayed in the capture area.

In the obtaining, when the pressure touch is released, the image displayed in the capture area may be obtained.

In the obtaining, when the pressure touch with a pressure having a magnitude greater than a predetermined magnitude is detected within the capture area after the pressure touch is released, or alternatively when a separate touch is detected on the touch screen while the pressure touch is applied, the image displayed in the capture area may be obtained.

The final touch position may be a position to which a drag operation is performed from the initial touch position, in a state where the pressure having a magnitude greater than a predetermined magnitude is maintained.

In the setting, an area defined by a quadrangle having diagonal vertices of the initial touch position and the final touch position may be set as the capture area.

Another embodiment is an image capturing method that includes: detecting, on a touch screen, a first pressure touch and a second pressure touch which have a pressure having a magnitude greater than a predetermined magnitude and are located in different positions; setting an area defined by a position of the first pressure touch and a position of the second pressure touch as a capture area; and obtaining an image displayed in the capture area.

In the obtaining, when the second pressure touch is released, the image displayed in the capture area may be obtained.

In the obtaining, when a third pressure touch with a pressure having a magnitude greater than a predetermined magnitude is detected within the capture area after the second pressure touch is released, or alternatively when a separate touch is detected on the touch screen while the second pressure touch is applied, the image displayed in the capture area may be obtained.

In the setting, an area defined by a quadrangle having diagonal vertices of the position of the first pressure touch and the position of the second pressure touch may be set as the capture area.

Further another embodiment is an image capturing method that includes: detecting a pressure touch with a pressure having a magnitude greater than a predetermined magnitude on a touch screen; displaying an entire area of the touch screen as a capture area when the pressure touch is detected; controlling a size and a position of the capture area on the basis of a user's touch; and obtaining an image displayed in the controlled capture area.

In the controlling, the size and position of the capture area may be controlled by an area defined by a quadrangle having diagonal vertices of a first drag position to which the touch has been dragged from the vertex of the entire area of the touch screen and a second drag position to which the touch has been dragged from the vertex of the entire area of the touch screen.

In the obtaining, when the pressure having a magnitude greater than a predetermined magnitude is detected within the controlled capture area, the image displayed in the capture area may be obtained.

Yet another embodiment is an image capturing method that includes: detecting a pressure touch with a pressure having a magnitude greater than a predetermined magnitude on a touch screen; displaying a capture area having a predetermined size when the pressure touch is detected; controlling such that the size of the capture area is enlarged or reduced according to a duration time or pressure increase/decrease of the pressure touch; obtaining an image displayed in the controlled capture area.

The image capturing method may further include controlling the position of the capture area such that the capture area is moved to a touch position to which the capture area is dragged after the controlling of the size of the capture area, on the basis of a user operation to touch and drag the controlled capture area.

In the obtaining, when the pressure touch with a pressure having a predetermined magnitude is detected within the capture area after the pressure touch is released, or alternatively when a separate touch is detected on the touch screen while the pressure touch is applied, the image displayed in the capture area may be obtained.

In the controlling, when the pressure touch is maintained for a period of time longer than a predetermined time period, the size of the capture area may be increased in proportion to the duration time of the pressure touch.

In the controlling, when the intensity of the pressure of the pressure touch increases, the size of the capture area may be increased, and when the intensity of the pressure of the pressure touch decreases, the size of the capture area may be reduced.

The touch screen may include a pressure electrode and a reference potential layer. In the detecting, on the basis of a capacitance which is changed by a distance change due to the touch pressure between the pressure electrode and the reference potential layer, the pressure touch with a pressure having a magnitude greater than a predetermined magnitude may be detected.

Still another embodiment is a mobile terminal that includes: a touch screen which detects a pressure touch with a pressure having a magnitude greater than a predetermined magnitude; a control unit which sets an area defined by an initial touch position and a final touch position of the pressure touch as a capture area, and obtains an image displayed in the set capture area; and a memory which stores the obtained image.

When the pressure touch is released, the control unit may obtain the image displayed in the capture area.

When the pressure touch with a pressure having a magnitude greater than a predetermined magnitude is detected within the capture area after the pressure touch is released, or alternatively when a separate touch is detected on the touch screen while the pressure touch is applied, the control unit may obtain the image displayed in the capture area. The final touch position may be a position to which a drag operation is performed from the initial touch position, in a state where the pressure having a magnitude greater than a predetermined magnitude is maintained.

The control unit may set an area defined by a quadrangle having diagonal vertices of the initial touch position and the final touch position as the capture area.

Still another embodiment is a mobile terminal that includes: a touch screen which detects a first pressure touch and a second pressure touch which have a pressure having a magnitude greater than a predetermined magnitude; a control unit which sets an area defined by the first pressure touch and the second pressure touch which are located in different positions as a capture area, and obtains an image displayed in the set capture area; and a memory which stores the obtained image.

When the second pressure touch is released, the control unit may obtain the image displayed in the capture area.

When a third pressure touch with a pressure having a magnitude greater than a predetermined magnitude is detected within the capture area after the second pressure touch is released, or alternatively when a separate touch is detected on the touch screen while the second pressure touch is applied, the control unit may obtain the image displayed in the capture area.

The control unit may set an area defined by a quadrangle having diagonal vertices of the position of the first pressure touch and the position of the second pressure touch as the capture area.

Still another embodiment is a mobile terminal that includes: a touch screen which detects a pressure touch with a pressure having a magnitude greater than a predetermined magnitude; a control unit which displays an entire area of the touch screen as a capture area when the pressure touch is detected, controls a size and a position of the capture area on the basis of a user's touch, and then obtains an image displayed in the controlled capture area; and a memory which stores the obtained image.

The control unit may control the size and position of the capture area by an area defined by a quadrangle having diagonal vertices of a first drag position to which the touch has been dragged from the vertex of the entire area of the touch screen and a second drag position to which the touch has been dragged from the vertex of the entire area of the touch screen.

When the pressure having a magnitude greater than a predetermined magnitude is detected within the controlled capture area, the control unit may obtain the image displayed in the capture area.

Still another embodiment is a mobile terminal that includes: a touch screen which detects a pressure touch with a pressure having a magnitude greater than a predetermined magnitude; a control unit which displays a capture area having a predetermined size on the touch screen when the pressure touch is detected, controls such that the size of the capture area is enlarged or reduced according to a duration time or pressure increase/decrease of the pressure touch, and then obtains an image displayed in the controlled capture area; and a memory which stores the obtained image.

The control unit may move the capture area to a touch position to which the capture area is dragged, on the basis of a user's touch which drags from the capture area as a start point.

When a user's touch is detected within the capture area after the pressure touch is released, or alternatively when a separate touch is detected on the touch screen while the pressure touch is applied, the control unit may obtain the image displayed in the capture area.

When the pressure touch is maintained for a period of time longer than a predetermined time period, the control unit may increase the size of the capture area in proportion to the duration time of the pressure touch.

When the intensity of the pressure of the pressure touch increases, the control unit may increase the size of the capture area, and when the intensity of the pressure of the pressure touch decreases, the control unit may reduce the size of the capture area.

The touch screen may include a pressure electrode and a reference potential layer. The control unit may determine whether the pressure touch with a pressure having a magnitude greater than a predetermined magnitude is applied or not, on the basis of a capacitance which is changed by a distance change due to the touch pressure between the pressure electrode and the reference potential layer.

### Advantageous Effects

According to the mobile terminal and image capturing method according to the embodiment of the present invention, it is possible to easily capture in various ways images displayed on the mobile terminal.

### DESCRIPTION OF DRAWINGS

FIG. 1 is a block diagram showing the configuration of a mobile terminal according to an embodiment of the present invention;

FIG. 2 shows a layer structure of a touch screen of the mobile terminal according to the embodiment of the present invention;

FIGS. 3a and 3b are views for describing the structure and operation of a touch input unit included in the touch screen of the mobile terminal according to the embodiment of the present invention;

FIGS. 4a to 4e are views showing the structure of a display included in the touch screen of the mobile terminal according to the embodiment of the present invention;

FIGS. 5a to 5d are views for describing a method for detecting whether a 3D touch has occurred or not and/or the strength of the touch on the basis of a mutual capacitance in the mobile terminal according to the embodiment of the present invention;

FIGS. 6a to 6c show a method for detecting whether a 3D touch has occurred or not and/or the strength of the touch on the basis of a self-capacitance in the mobile terminal according to the embodiment of the present invention;

FIG. 7 is a view showing an image capturing method according to a first embodiment in the mobile terminal according to the present invention;

FIG. 8 is a view showing an image capturing method according to a second embodiment in the mobile terminal according to the present invention;

FIG. 9 is a view showing an image capturing method according to a third embodiment in the mobile terminal according to the present invention;

FIGS. 10a and 10b are views showing an image capturing method according to a fourth embodiment in the mobile terminal according to the present invention;

FIGS. 11a and 11b are views showing an image capturing method according to a fifth embodiment in the mobile terminal according to the present invention;

FIGS. 12a and 12b are views showing the image capturing method according to the first embodiment of the present invention;

FIGS. 13a and 13b are views showing the image capturing method according to the second embodiment of the present invention;

FIG. 14 is a flowchart showing the image capturing method according to the third embodiment of the present invention;

FIGS. 15a and 15b are flowcharts showing the image capturing method according to the fourth embodiment of the present invention; and

FIGS. 16a and 16b are flowcharts showing the image capturing method according to the fifth embodiment of the present invention.

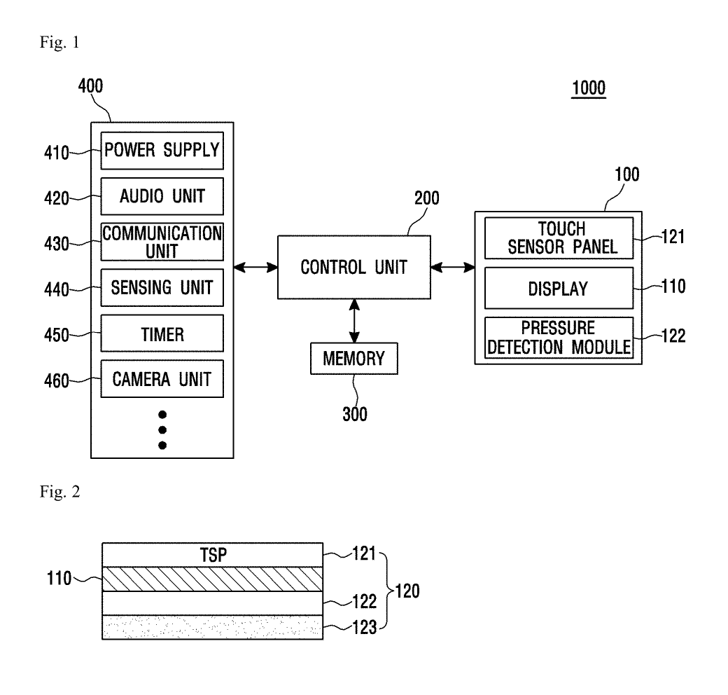

### MODE FOR INVENTION

The 2D touch information means information on whether the touch is input or not (whether the touch occurs or not) and on which position in the surface of the touch screen the touch is input to (touch position). The 3D touch information means information on a pressure (force) of the touch applied to the surface of the touch screen 100. That is, the 3D touch information may be information on a touch having a sufficient pressure for the surface of the touch screen to be bent at the position of the user's touch. However, in another embodiment, the 3D touch may mean a touch which has a pressure sufficient to be sensed by a separate pressure sensor even without the bending of the touch screen surface.

The structure, function, and operation of the display 110, the touch sensor panel 121, and the pressure detection module 122 included in the touch screen 100 will be described below in more detail.

The memory 300 has a function of storing various information required for the operation of the mobile terminal 1000 according to the embodiment of the present invention or of storing picture/video files photographed by the camera unit 460 or screen images generated by screen capture. The image stored in the memory 300 can be controlled to be displayed through the touch screen 100 on the basis of a user operation signal.

The control unit 200 controls the touch screen 100, the memory 300, and the other units 400 to perform a predetermined operation on the basis of a user operation (command) input from the touch screen 100. The control of the control unit 200 will be described in detail below together with specific embodiments.

As other configurations, the other units 400 may include the power supply 410 which supplies power for operating each of the components, the audio unit 420 which is involved in the input and output of voice and sound, the communication unit 430 which performs voice communication with a communication terminal or performs data communication with a server, the sensing unit 440 which includes a gyro sensor, an acceleration sensor, a vibration sensor, a proximity sensor, a magnetic sensor, etc., and the timer 450 which checks a call time period, a touch duration time, etc. However, the above components may be omitted or replaced if necessary, or alternatively, other components may be added.

Structure of Touch Screen 100

FIG. 2 shows a layer structure of the touch screen 100 of the mobile terminal 1000 according to the embodiment of the present invention. As shown in FIG. 2, the touch screen 100 of the mobile terminal 1000 according to the embodiment of the present invention includes the touch sensor panel 121, the display 110, the pressure detection module 122, and a substrate 123. In FIG. 2, the touch sensor panel 121, the pressure detection module 122, and the substrate 123 constitute a touch input unit 120 which receives the user's touch.

The display 110 has a function of displaying texts, images (still images, dynamic images, 3D images, etc.), colors, and the like.

The touch sensor panel 121 detects information on the 2D touch. The 2D touch is a term corresponding to the 3D touch to be described below, and refers to a touch that is merely contact or a touch that has a pressure having a magnitude less than a predetermined magnitude. Specifically, the 2D touch may mean a touch having a force enough for the touch screen not to be bent or a touch having a force enough for a separate pressure sensor not to recognize the touch as a pressure.

That is, the information on the 2D touch refers to information on whether or not the touch occurs on the touch screen surface, the position and the number of touches occurring on the touch screen surface, and the touch movement direction.

The pressure detection module 122 detects information on the 3D touch. The 3D touch is a term corresponding to the above 2D touch and means a touch that has a pressure having a magnitude greater than a predetermined magnitude. Specifically, the 3D touch may mean a touch having a force enough for the touch screen to be bent or a touch having a force enough for a separate pressure sensor to recognize the touch as a pressure.

That is, the information on the 3D touch refers to information on the strength or strength change of the 3D touch, the duration time of the 3D touch, and the like.

The substrate 123 may be a reference potential layer used for 3D touch detection. In FIG. 2, although the reference potential layer is disposed under the pressure detection module 122, the reference potential layer may be disposed on the pressure detection module 122 or within the display 110 in other embodiments.

Further, although one reference potential layer (substrate 123) is shown in FIG. 2, two or more reference potential layers may be used in other embodiments. The arrangement and the number of the pressure detecting modules 122 can be appropriately changed, as necessary.

2D Touch Detection

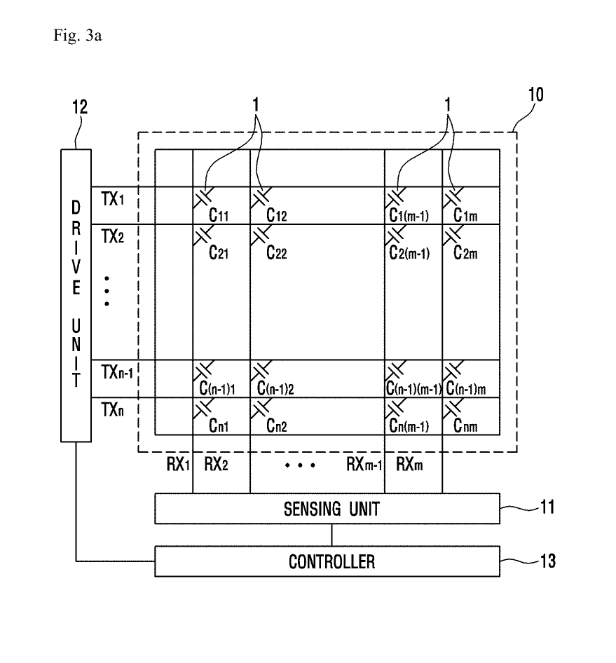

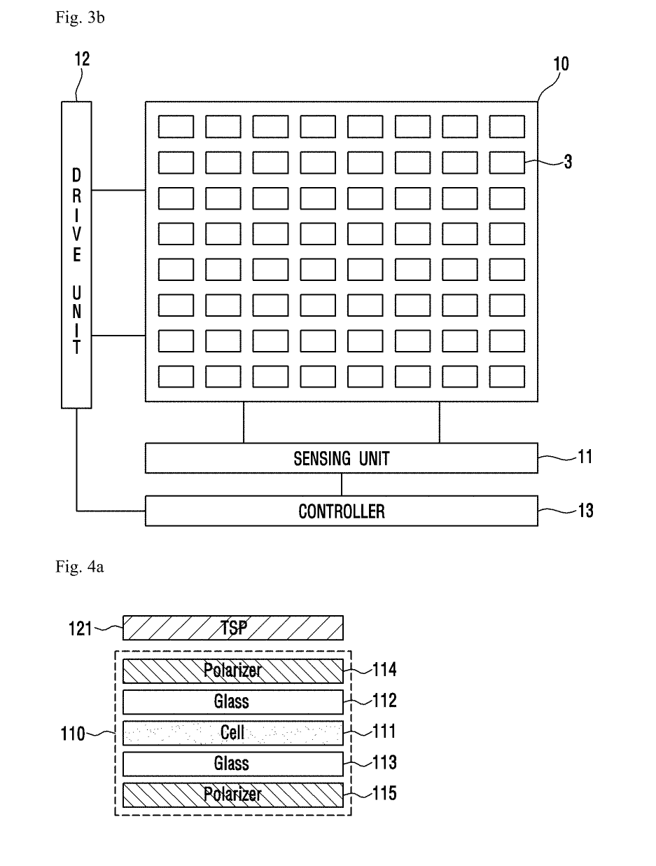

FIGS. 3a and 3b show the structure and operation of the touch sensor panel 121 included in the touch screen 100 of the mobile terminal 1000 according to the embodiment of the present invention.

FIG. 3a is a schematic view of a configuration of a mutual capacitance touch sensor panel 121 and the operation thereof in accordance with the embodiment of the present invention. Referring to FIG. 3a, the touch sensor panel 121 may include a plurality of drive electrodes TX1 to TXn and a plurality of receiving electrodes RX1 to RXm, and may include a drive unit 12 which applies a drive signal to the plurality of drive electrodes TX1 to TXn for the purpose of the operation of the touch sensor panel 121, and a sensing unit 11 which detects whether the touch has occurred or not and/or the touch position by receiving a sensing signal including information on the capacitance change amount changing according to the touch on the touch surface of the touch sensor panel 121.

As shown in FIG. 3a, the touch sensor panel 121 may include the plurality of drive electrodes TX1 to TXn and the plurality of receiving electrodes RX1 to RXm. FIG. 3 shows that the plurality of drive electrodes TX1 to TXn and the plurality of receiving electrodes RX1 to RXm of the touch sensor panel 121 form an orthogonal array. In another embodiment, the plurality of drive electrodes TX1 to TXn and the plurality of receiving electrodes RX1 to RXm may form an array of different patterns.

The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

In the touch sensor panel 121, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on the same side of an insulation layer (not shown). Also, the plurality of drive electrodes TX1 to TXn and the plurality of receiving electrodes RX1 to RXm may be formed in different layers. For example, the plurality of drive electrodes TX1 to TXn and the plurality of receiving electrodes RX1 to RXm may be formed on both sides of one insulation layer (not shown) respectively, or the plurality of drive electrodes TX1 to TXn may be formed on a side of a first insulation layer (not shown) and the plurality of receiving electrodes RX1 to RXm may be formed on a side of a second insulation layer (not shown) different from the first insulation layer.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may include at least any one of silver ink, copper, and carbon nanotube (CNT). Also, the drive electrode TX and the receiving electrode RX may be made of metal mesh or nano silver.

The drive unit 12 may apply a drive signal to the drive electrodes TX1 to TXn. In the embodiment of the present invention, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 11 receives the sensing signal including information on a capacitance (Cm) 1 generated between the receiving electrodes RX1 to RXm and the drive electrodes TX1 to TXn to which the drive signal has been applied, thereby detecting whether or not the touch has occurred and the touch position. For example, the sensing signal may be a signal coupled by the capacitance (CM) 1 generated between the receiving electrode RX and the drive electrode TX to which the drive signal has been applied. As such, the process of sensing the drive signal applied from the first drive electrode TX1 to the n-th drive electrode TXn through the receiving electrodes RX1 to RXm can be referred to as a process of scanning the touch sensor panel 100. As such, the process of sensing the drive signal applied from the first drive electrode TX1 to the n-th drive electrode TXn through the receiving electrodes RX1 to RXm can be referred to as a process of scanning the touch sensor panel 100.

For example, the sensing unit 11 may include a receiver (not shown) which is connected to each of the receiving electrodes RX1 to RXm through a switch. The switch becomes the on-state in a time interval during which the signal of the corresponding receiving electrode RX is sensed, thereby allowing the receiver to sense the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (CM) 1, and then converts the integrated current signal into voltage. The sensing unit 11 may further include an analog to digital converter (ADC) (not shown) which converts the integrated data by the receiver into digital data. Later, the digital data may be input to a processor (not shown) and processed to obtain information on the touch on the touch sensor panel 121. The sensing unit 11 may include the ADC and processor as well as the receiver.

A controller 13 may perform a function of controlling the operations of the drive unit 12 and the sensing unit 11. For example, the controller 13 generates and transmits a drive control signal to the drive unit 12, so that the drive signal can be applied to a predetermined drive electrode TX1 at a predetermined time. Also, the controller 13 generates and transmits a sensing control signal to the sensing unit 11, so that the sensing unit 11 may receive the sensing signal from the predetermined receiving electrode RX at a predetermined time and perform a predetermined function.

In FIG. 3a, the drive unit 12 and the sensing unit 11 may constitute a touch detection device (not shown) capable of detecting whether or not the touch has occurred on the touch screen 100 and the touch position in the mobile terminal 1000 according to the embodiment of the present invention. The touch detection device may further include the controller 13. The touch detection device may be integrated and implemented on a touch sensing integrated circuit (IC) in the mobile terminal 1000 including the touch sensor panel 121. The drive electrode TX and the receiving electrode RX included in the touch sensor panel 121 may be connected to the drive unit 12 and the sensing unit 11 included in the touch sensing IC (not shown) through, for example, a conductive trace and/or a conductive pattern printed on a circuit board, or the like. The touch sensing IC may be placed on a circuit board on which the conductive pattern has been printed, for example, a first printed circuit board (hereafter, referred to as a first PCB). According to the embodiment, the touch sensing IC may be mounted on a main board for operation of the mobile terminal 1000.

As described above, a capacitance (Cm) 1 with a predetermined value is generated at each crossing of the drive electrode TX and the receiving electrode RX. When an object U like a finger, palm, or stylus, etc., approaches close to the touch sensor panel 121, the value of the capacitance may be changed.

In FIG. 3a, the capacitance may represent a mutual capacitance (Cm). The sensing unit 11 senses such electrical characteristics, thereby being able to sense whether the touch has occurred on the touch sensor panel 121 or not and where the touch has occurred. For example, the sensing unit 11 is able to sense whether the touch has occurred on the surface of the touch sensor panel 121 comprised of a two-dimensional plane consisting of a first axis and a second axis.

More specifically, when the touch occurs on the touch sensor panel 121, the drive electrode TX to which the drive signal has been applied is detected, so that the position of the second axial direction of the touch can be detected. Likewise, when the touch occurs on the touch sensor panel 121, the capacitance change is detected from the reception signal received through the receiving electrode RX, so that the position of the first axial direction of the touch can be detected.

In the foregoing, the operation method of the touch sensor panel 121 which detects whether the touch has occurred or not or the touch position has been described based on the change amount of the mutual capacitance (Cm) between the drive electrode TX and the receiving electrode RX. However, there is no limitation to this. As shown in FIG. 3b, the touch position can be also detected based on the change amount of a self-capacitance.

As shown in FIG. 3b, the touch sensor panel 121 may include a plurality of touch electrodes 3. The plurality of touch electrodes 3 may be, as shown in FIG. 3a, arranged at a regular interval in the form of a grid. However, there is no limitation to this.

The drive control signal generated by the controller 13 is transmitted to the drive unit 12, and the drive unit 12 applies the drive signal to a predetermined touch electrode 3 for a predetermined time. Also, the sensing control signal generated by the controller 13 is transmitted to the sensing unit 11, and on the basis of the detection control signal, the sensing unit 11 receives the sensing signal from the predetermined touch electrode 3 for a predetermined time. Here, the sensing signal may be a signal for the change amount of the self-capacitance formed on the touch electrode 3.

Here, whether or not the touch has occurred on the touch sensor panel 121 and/or the touch position are detected by the sensing signal detected by the sensing unit 11. For example, because the coordinates of the touch electrode 3 have been known in advance, whether or not the touch of the object U has occurred on the surface of the touch sensor panel 121 and/or the touch position can be detected.

Referring to FIGS. 3a and 3b, the foregoing has described in detail the touch sensor panel 121 which detects whether or not the touch has occurred and/or the touch position on the basis of the change amount of the mutual capacitance (Cm) and the change amount of the self-capacitance (Cs). However, the touch sensor panel 121 may be implemented by using not only the above-described methods but also any touch sensing method such as a surface capacitance type method, a projected capacitance type method, a resistance film method, a surface acoustic wave (SAW) method, an infrared method, an optical imaging method, a dispersive signal technology, and an acoustic pulse recognition method, etc.

Structure of Display

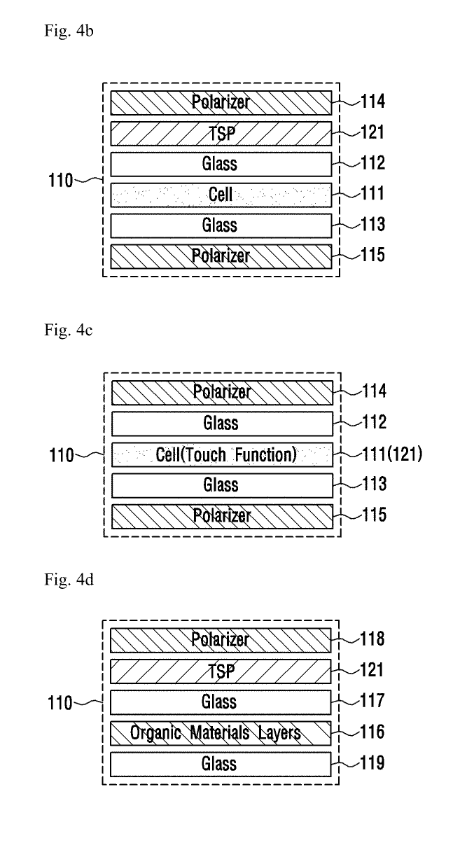

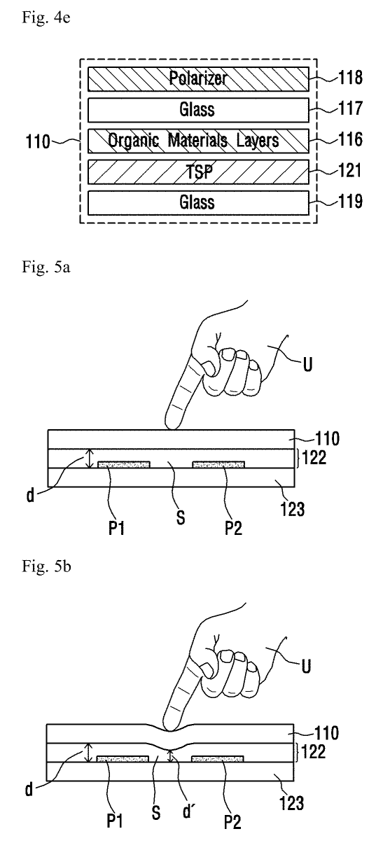

FIGS. 4a to 4e are views showing the structure of the display 110 included in the touch screen 100 of the mobile terminal 1000 according to the embodiment of the present invention. FIGS. 4a to 4e show various layer structures of the display 110 and the touch sensor panel 121 of FIG. 2. Specifically, FIGS. 4a to 4c show the display 110 using an LCD panel. FIGS. 4d and 4e show the display 110 using an OLED panel.

As shown in FIGS. 4a to 4c, the LCD panel may include a liquid crystal layer 111 including a liquid crystal cell, a first glass layer 112 and a second glass layer 113 which are disposed on both sides of the liquid crystal layer 111 and include electrodes, a first polarizer layer 114 formed on a side of the first glass layer 112 in a direction facing the liquid crystal layer 111, and a second polarizer layer 115 formed on a side of the second glass layer 113 in the direction facing the liquid crystal layer 111. Here, the first glass layer 112 may be color filter glass, and the second glass layer 113 may be TFT glass. It is clear to those skilled in the art that the LCD panel may further include other configurations for the purpose of performing the displaying function and may be transformed.

FIG. 4a shows that the touch sensor panel 121 is disposed outside the display 110. Here, the surface of the mobile terminal 1000 where the touch occurs may be the surface of the touch sensor panel 121. Specifically, the user's touch may occur on the top surface of the touch sensor panel 121. Also, according to the embodiment, the touch surface of the mobile terminal 1000 may be the outer surface of the display 110. In FIG. 4a, the bottom surface of the second polarizer layer 115 of the display 110 is able to function as the touch surface. Here, in order to protect the display 110, the bottom surface of the display 110 may be covered with a cover layer (not shown) like glass.

FIGS. 4b and 4c show that the touch sensor panel 121 is disposed inside the display panel 110. In FIG. 4b, the touch sensor panel 121 for detecting the touch position is disposed between the first glass layer 112 and the first polarizer layer 114. Here, the touch surface of the mobile terminal 1000 is the outer surface of the display 110. The top surface or bottom surface of the layer structure shown in FIG. 4b may be the touch surface of the mobile terminal 1000.

In FIG. 4c, the touch sensor panel 121 for detecting the touch position is included within the liquid crystal layer 111. Here, the touch surface of the mobile terminal 1000 is the outer surface of the display 110. The top surface or bottom surface of the layer structure shown in FIG. 4c may be the touch surface. In FIGS. 4b and 4c, the top surface or bottom surface of the display 110, which can be the touch surface, may be covered with a cover layer (not shown) like glass.

As shown in FIGS. 4d and 4e, the OLED panel includes a first polarizer layer 118, a first glass layer 117, an organic material layer 116, and a second glass layer 119. Here, the first glass layer 117 may be made of encapsulation glass. The second glass layer 119 may be made of TFT glass. However, there is no limitation to this.

Also, the organic material layer 116 may include a hole injection layer (HIL), a hole transport layer (HTL), an electron injection layer (EIL), an electron transport layer (ETL), and an light-emitting layer (EML). The HIL injects electron holes and is made of a material such as CuPc, etc. The HTL functions to move the injected electron holes and mainly is made of a material having a good hole mobility. Arylamine, TPD, and the like may be used as the HTL. The EIL and ETL inject and transport electrons. The injected electrons and electron holes are combined in the EML and emit light. The EML represents the color of the emitted light and is composed of a host determining the lifespan of the organic matter and an impurity (dopant) determining the color sense and efficiency. This just describes the basic structure of the organic material layer 280 include in the OLED panel. The present invention is not limited to the layer structure or material, etc., of the organic material layer 116.

The organic material layer 116 is inserted between an anode (not shown) and a cathode (not shown). When the TFT becomes an on-state, a driving current is applied to the anode and the electron holes are injected, and the electrons are injected to the cathode. Then, the electron holes and electrons move to the organic material layer 116 and emit the light.

In FIG. 4d, the touch sensor panel 121 is located between the first polarizer layer 118 and the first glass layer 117. In FIG. 4e, the touch sensor panel 121 is located between the organic material layer 116 and the second glass layer 119.

The first glass layer 117 may be made of encapsulation glass. The second glass layer 119 may be made of TFT glass.

The OLED panel is a self-light emitting display panel which uses a principle where, when current flows through a fluorescent or phosphorescent organic thin film and then electrons and electron holes are combined in the organic material layer, so that light is generated. The organic matter constituting the light emitting layer determines the color of the light.

Specifically, the OLED uses a principle in which when electricity flows and an organic matter is applied on glass or plastic, the organic matter emits light. That is, the principle is that electron holes and electrons are injected into the anode and cathode of the organic matter respectively and are recombined in the light emitting layer, so that a high energy exciton is generated and the exciton releases the energy while falling down to a low energy state and then light with a particular wavelength is generated. Here, the color of the light is changed according to the organic matter of the light emitting layer.

The OLED includes a line-driven passive-matrix organic light-emitting diode (PM-OLED) and an individual driven active-matrix organic light-emitting diode (AM-OLED) in accordance with the operating characteristics of a pixel constituting a pixel matrix. None of them require a backlight. Therefore, the OLED enables a very thin display to be implemented, has a constant contrast ratio according to an angle and obtains a good color reproductivity depending on a temperature. Also, it is very economical in that non-driven pixel does not consume power.

In terms of operation, the PM-OLED emits light only during a scanning time at a high current, and the AM-OLED maintains a light emitting state only during a frame time at a low current. Therefore, the AM-OLED has a resolution higher than that of the PM-OLED and is advantageous for driving a large area display panel and consumes low power. Also, a thin film transistor (TFT) is embedded in the AM-OLED, and thus, each component can be individually controlled, so that it is easy to implement a delicate screen.

3D Touch Detection

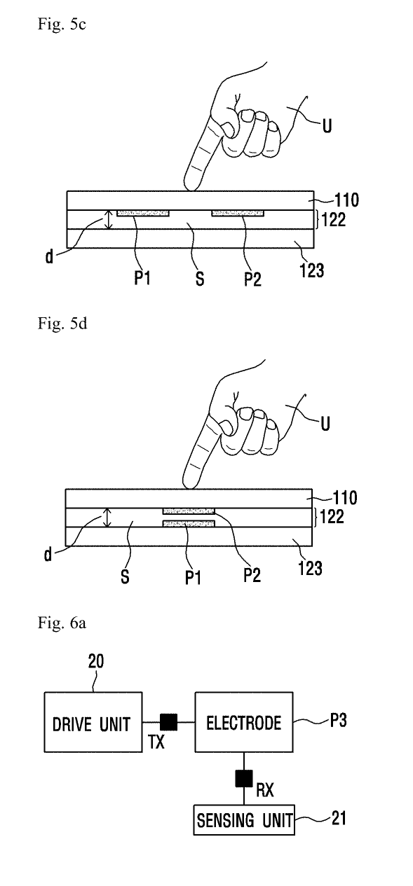

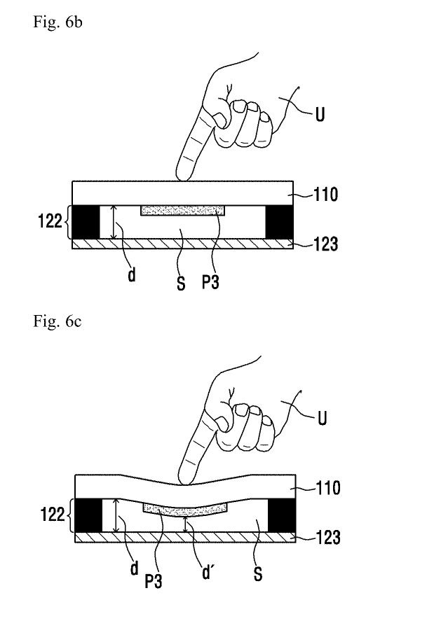

FIGS. 5a to 5d and 6a to 6c show the operation and detection method of the pressure detection module 122 of the mobile terminal 1000 according to the embodiment of the present invention.

FIGS. 5a to 5d show a method in which the pressure detection module 122 detects whether the 3D touch has occurred or not and/or the strength of the 3D touch on the basis of the mutual capacitance between pressure electrodes.

As shown in FIG. 5a, a spacer layer S may be disposed between the display 110 and the substrate 123. Pressure electrodes P1 and P2 disposed according to the embodiment shown in FIG. 5a may be disposed on the substrate 123 side.

The pressure detection module 122 may include the first electrode P1 and the second electrode P2 as pressure electrodes for pressure detection. Here, any one of the first electrode P1 and the second electrode P2 may be the drive electrode, and the other may be the receiving electrode. A drive signal is applied to the drive electrode, and a sensing signal is obtained through the receiving electrode. When voltage is applied, the mutual capacitance Cm is generated between the first electrode P1 and the second electrode P2.

FIG. 5b shows that a 3D touch, i.e., a touch having a pressure is applied to the touch screen 100 shown in FIG. 5a. The bottom surface of the display 110 may have a ground potential in order to shield the noise. When the 3D touch with a pressure having a magnitude greater than a predetermined magnitude is applied to the surface of the touch screen 100 by the object U, the touch sensor panel 121 and the display 110 may be bent. As a result, a distance “d” between a ground potential surface, i.e., the reference potential layer and the two pressure electrodes P1 and P2 is reduced to “d′”. As a result, a fringing capacitance is absorbed in the bottom surface of the display 110, so that the mutual capacitance between the first electrode P1 and the second electrode P2 is reduced. By using this, the magnitude of the touch pressure can be calculated by obtaining the reduction amount of the mutual capacitance from the sensing signal obtained through the receiving electrode.

FIG. 5c shows the configuration of the pressure detection module 122 according to another embodiment of the present invention. In the electrode arrangement shown in FIG. 5c, the pressure electrodes P1 and P2 are disposed on the display 110 side between the display 110 and the substrate 123

The substrate 123 as the reference potential layer may have a ground potential. Therefore, as the 3D touch occurs, the distance “d” between the substrate 123 and the pressure electrodes P1 and P2 is reduced to “d′”. Consequently, this causes the change of the mutual capacitance between the first electrode P1 and the second electrode P2.

FIG. 5d shows the configuration of the pressure detection module 122 according to further another embodiment of the present invention. As shown in FIG. 5d, any one of the first electrode P1 and the second electrode P2 may be formed on the substrate 123, and the other may be formed under the display 110. FIG. 5d shows that the first electrode P1 is formed on the substrate 123 and the second electrode P2 is formed under the display 110. Further, the positions of the first electrode P1 and the second electrode P2 can be replaced with each other.

The principle of the structure of FIG. 5d is the same as that described above. That is, when the 3D touch is applied to the surface of the touch screen 100 by the object U, the bending occurs and the distance “d” between the first electrode P1 and the second electrode P2 is reduced to “d′”. Accordingly, the mutual capacitance between the first electrode P1 and the second electrode P2 is changed. Therefore, the magnitude of the touch pressure can be calculated by obtaining the reduction amount of the mutual capacitance from the sensing signal obtained through the receiving electrode.

Unlike the foregoing, whether the 3D touch has occurred or not and the strength of the 3D touch can be detected based on the self-capacitance of the pressure electrode. FIGS. 6a to 6c show a method in which the pressure detection module 122 detects whether the 3D touch has occurred or not and/or the strength of the 3D touch on the basis of the self-capacitance between pressure electrodes.

The pressure detection module 122 for detecting the change amount of the self-capacitance uses a pressure electrode P3 formed under the display 110. When a drive signal is applied to the pressure electrode P3, the pressure detection module receives a signal including information on the change amount of the self-capacitance, and detects whether the 3D touch has occurred or not and/or the strength of the 3D touch.

The drive unit 20 applies a drive signal to the pressure electrode P3 and the sensing unit 21 measures a capacitance between the pressure electrode P3 and the reference potential layer 123 (e.g., the substrate) having a reference potential through the pressure electrode P3, thereby detecting whether the 3D touch has occurred or not and/or the strength of the 3D touch.

The drive unit 20 may include, for example, a clock generator (not shown) and a buffer to generate a drive signal in the form of a pulse and to apply the generated drive signal to the pressure electrode P3. However, this is merely an example, and the drive unit can be implemented by means of various elements, and the shape of the drive signal can be variously changed.

The drive unit 20 and the sensing unit 21 may be implemented as an integrated circuit or may be formed on a single chip. The drive unit 20 and the sensing unit 21 may constitute a pressure detector.

In order that the capacitance change amount is easily detected between the pressure electrode P3 and the reference potential layer 123, the pressure electrode P3 may be formed such that there is a larger facing surface between the pressure electrode P3 and the reference potential layer 123. For example, the pressure electrode P3 may be formed in a plate-like pattern.

With regard to the detection of the touch pressure in the self-capacitance type method, here, one pressure electrode P3 is taken as an example for description. However, the plurality of electrodes are included and a plurality of channels are constituted, so that it is possible to configure that the magnitude of multi pressure can be detected according to multi touch.

The self-capacitance of the pressure electrode P3 is changed by the change of the distance between the pressure electrode p3 and the reference potential layer 123. Then, the sensing unit 21 detects information on the capacitance change, and thus detects whether the 3D touch has occurred or not and/or the strength of the 3D touch.

FIG. 6b shows the layer structure of the pressure detection module 122 for detecting the 3D touch by using the above-described self-capacitance change amount. As shown in FIG. 6b, the pressure electrode P3 is disposed apart from the reference potential layer 123 by a predetermined distance “d”. Here, a material which is deformable by the pressure applied by the object U may be disposed between the pressure electrode P3 and the reference potential layer 123. For instance, the deformable material disposed between the pressure electrode P3 and the reference potential layer 123 may be air, dielectrics, an elastic body and/or a shock absorbing material.

When the object U applies the 3D touch with a pressure having a magnitude greater than a predetermined magnitude to the touch surface, the pressure electrode P3 and the reference potential layer 123 become close to each other by the applied pressure, and the spaced distance “d” is reduced.

FIG. 6c shows that a pressure is applied by the object U and the touch surface is bent downward. As the distance between the pressure electrode P3 and the reference potential layer 123 is reduced from “d” to “d′”, the self-capacitance is changed. Specifically, the self-capacitance generated between the pressure electrode P3 and the reference potential layer 123 is increased. Whether or not the thus generated self-capacitance is changed and the change amount of the thus generated self-capacitance are measured by the sensing unit 21, thereby determining whether the 3D touch has occurred or not and/or the strength of the 3D touch.

### First Embodiment

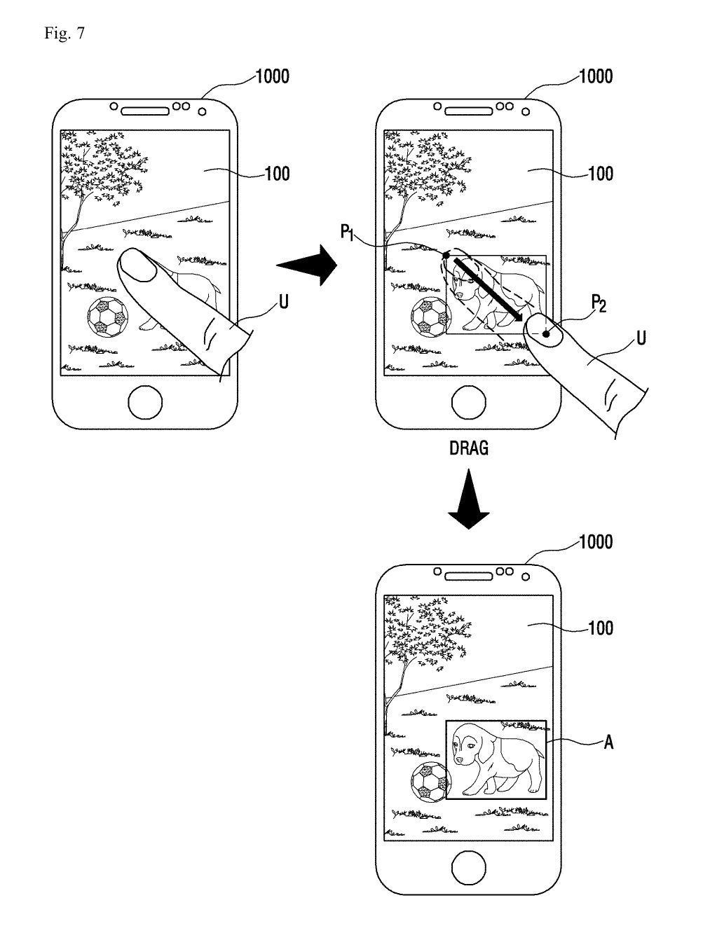

FIG. 7 shows an image capturing method according to a first embodiment in the mobile terminal 1000 according to the present invention.

When a user U applies a 3D touch with a pressure having a magnitude greater than a predetermined magnitude to the touch screen 100 and then drags the touch in a predetermined direction, the control unit 200 sets an area defined by an initial touch position and a final touch position of the 3D touch as a capture area.

Referring to FIG. 7, when a user operation to drag from the initial touch position P1 of the 3D touch to the final touch position P2 is detected, the control unit 200 determines the initial touch position P1 and the final touch position P2, and sets the capture area “A” defined by each position.

The capture area “A” may be, as shown in FIG. 7, an area defined by a quadrangle having diagonal vertices of the initial touch position P1 and the final touch position P2. However, in another embodiment, the capture area “A” may be defined by a polygon, a circle, or an ellipse, etc., defined by the initial touch position P1 and the final touch position P2.

The user operation for setting the capture area “A”, i.e., the drag operation on the touch screen 100, may be a drag operation (3D drag) from the initial touch position P1 to the final touch position P2 in a state where the pressure having a magnitude greater than a predetermined magnitude is maintained. However, there is no limitation to this. The user operation may be a drag operation (2D drag) from the initial touch position P1 to the final touch position P2 by the 2D touch in a state where a pressure having a magnitude less than a predetermined magnitude is maintained.

When the 3D touch is released, the control unit 200 obtains the image displayed in the capture area “A”. The user U sets the capture area “A” by a simple operation of applying the 3D touch to the touch screen 100 and of performing the drag operation to set the capture area “A” and then of releasing a finger from the touch screen 100 (releasing the 3D touch), and thus, obtains the image displayed in the capture area “A”.

Here, the image should be construed to include all the attributes which are displayed or can be displayed on the touch screen 100 in the form of texts, symbols, letters, and numbers, etc., as well as pictures or video frames displayed on the touch screen 100.

Meanwhile, the control unit 200 can obtain an image by receiving a separate user operation again after the capture area “A” is set by the drag operation of the user U. For example, when a touch (2D or 3D touch) is input in the capture area “A” after the capture area “A” is set, the control unit 200 obtains the image displayed in the capture area “A”. In addition, when a separate capture button is displayed in a portion of the touch screen 100 and the touch (2D or 3D touch) is input to the area where the capture button is displayed, the control unit 200 can obtain the image displayed in the capture area “A”.

Also, the control unit 200 may obtain an image by a multi-touch operation. Specifically, when a separate touch (2D or 3D touch) is detected on the touch screen 100 while a touch (2D or 3D touch) for setting the capture area “A” is input, the control unit 200 can obtain the image displayed in the capture area “A”.

In this embodiment, since the separate user operation (2D or 3D touch input) is required, a user operation for moving the capture area “A” may be input before the user operation for obtaining the image is input.

In other words, when the user U touches and drags the capture area “A” in the state where the capture area “A” is set, the control unit 200 senses this and moves the capture area “A” to the position to which the capture area “A” is dragged. When the 2D touch or the 3D touch is input to the moved capture area “A”, the control unit 200 can capture the image displayed in the moved capture area “A”.

The obtained image is stored in the memory 300 and the control unit 200 can display the image stored in the memory 300 on the touch screen 100.

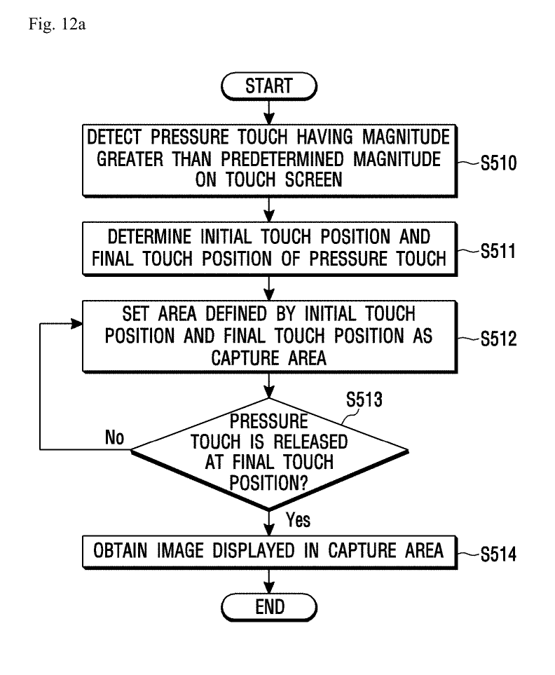

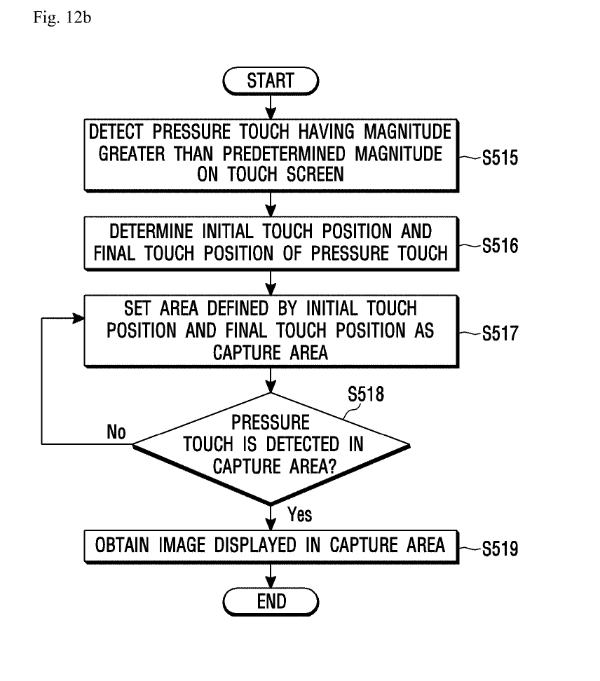

FIGS. 12a and 12b are flowcharts showing the image capturing method according to the embodiment of the present invention and relate to the above-described the first embodiment.

Referring to the flowchart shown in FIG. 12a, in the image capturing method according to the embodiment of the present invention, first, a 3D touch with a pressure having a magnitude greater than a predetermined magnitude is detected on the touch screen 100 (S510). Then, the initial touch position P1 and the final touch position P2 of the 3D touch are determined (S511), and an area defined by the initial touch position P1 and the final touch position P2 is set as the capture area “A” (S512). Since the method of setting the capture area “A” is the same as that described above, a description thereof will be omitted. When the 3D touch is released at the final touch position P2 (S513—YES), the image displayed in the set capture area “A” is obtained (S514).

Referring to the flowchart shown in FIG. 12b, in the image capturing method according to the embodiment of the present invention, first, a 3D touch with a pressure having a magnitude greater than a predetermined magnitude is detected on the touch screen 100 (S515). Then, the initial touch position P1 and the final touch position P2 of the 3D touch are determined (S516), and an area defined by the initial touch position P1 and the final touch position P2 is set as the capture area “A” (S517). When the 3D touch is detected again in the capture area “A” (S518—YES), the image displayed in the set capture area “A” is obtained (S519).

The difference in the flowcharts of FIGS. 12a and 12b is how to obtain the image displayed in the capture area “A”. The image obtainment time of the method shown in FIG. 12a is earlier than that of the method shown in FIG. 12b because the image is obtained only by releasing the 3D touch. On the other hand, unlike the method shown in FIG. 12a, the method shown in FIG. 12b is able to allow the capture area “A” to be modified or moved.

### Second Embodiment

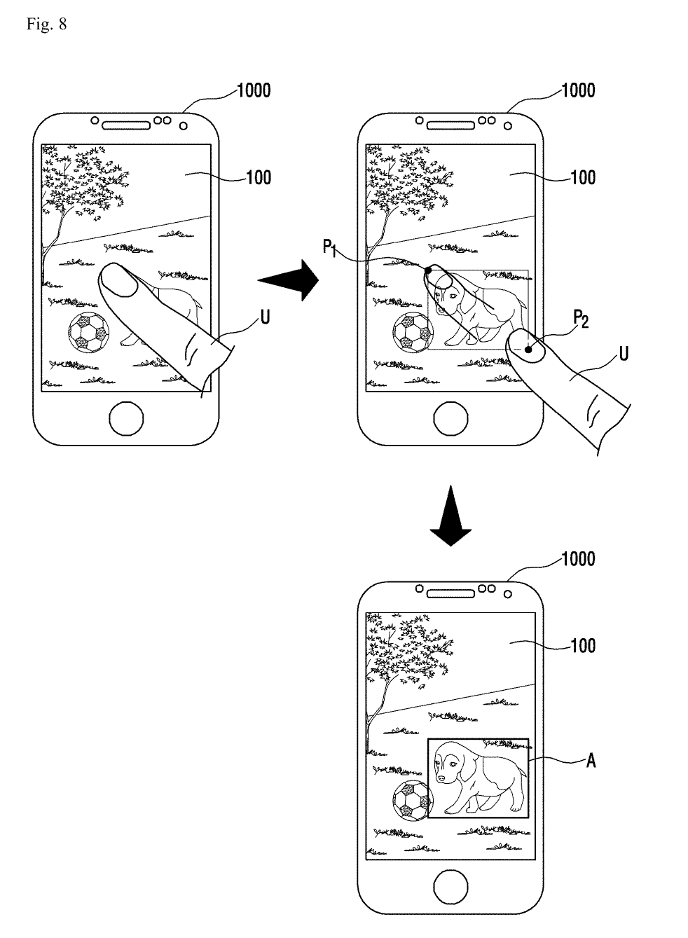

FIG. 8 is a view showing an image capturing method according to a second embodiment in the mobile terminal 1000 according to the present invention.

The user U may input the first 3D touch and the second 3D touch to the touch screen 100. Here, the positions of the first 3D touch and the second 3D touch on the touch screen 100 are different from each other, and both the first 3D touch and the second 3D touch have a pressure having a magnitude greater than a predetermined magnitude.

Also, the first 3D touch and the second 3D touch may be input sequentially or simultaneously. For example, when the user U sequentially inputs the first 3D touch and then inputs the second 3D touch with one finger (sequential 3D touch), the first 3D touch and the second 3D touch are sequentially detected. When the user U inputs the first 3D touch and the second 3D touch simultaneously with two fingers (multi 3D touch), the first 3D touch and the second 3D touch are detected at the same time. According to the second embodiment, the user U can set the capture area “A” in a manner convenient for the user U himself/herself.

In this embodiment, the control unit 200 sets an area defined by the position P1 of the first 3D touch and the position P2 of the second 3D touch as the capture area “A”. Specifically, the control unit 200 may set an area defined by a quadrangle having diagonal vertices of the position P1 of the first 3D touch and the position P2 of the second 3D touch as the capture area “A”. However, the shape of the capture area “A” is not limited to the quadrangle, and may be defined by a polygon, a circle, or an ellipse, etc., defined by the position P1 of the first 3D touch and the position P2 of the second 3D touch.

The control unit 200 can obtain the image displayed in the capture area “A” when the second 3D touch is released. According to this, The user U sets the capture area “A” only by a simple operation of sequentially inputting the first 3D touch and the second 3D touch on the touch screen 100 and of releasing the finger (releasing the second 3D touch), and easily obtains the image displayed in the capture area “A”.

Also, the control unit 200 may obtain an image by a multi-touch operation. Specifically, when a separate touch (2D or 3D touch) is detected on the touch screen 100 while a touch (2D or 3D touch) (here, which may correspond to the second 3D touch) for setting the capture area “A” is input, the control unit 200 can obtain the image displayed in the capture area “A”.

Meanwhile, the control unit 200 can obtain an image by receiving a separate user operation again after the capture area “A” is set by inputting the first 3D touch and the second 3D touch. For example, when a touch (2D or 3D touch) is input in the capture area “A” after the capture area “A” is set, the control unit 200 obtains the image displayed in the capture area “A”. In addition, when a separate capture button is displayed in a portion of the touch screen 100 and the touch (2D or 3D touch) is input to the area where the capture button is displayed, the control unit 200 can obtain the image displayed in the capture area “A”.

In this embodiment, since the separate user operation (2D or 3D touch input) is required, a user operation for moving the capture area “A” may be input before the user operation for obtaining the image is input.

In other words, when the user U touches and drags the capture area “A” in the state where the capture area “A” is set, the control unit 200 senses this and moves the capture area “A” to the position to which the capture area “A” is dragged. When the 2D touch or the 3D touch is input to the moved capture area “A”, the control unit 200 can capture the image displayed in the moved capture area “A”.

The obtained image may be stored in the memory 300, and the control unit 200 may read the image stored in the memory 300 and display the read image on the touch screen 100.

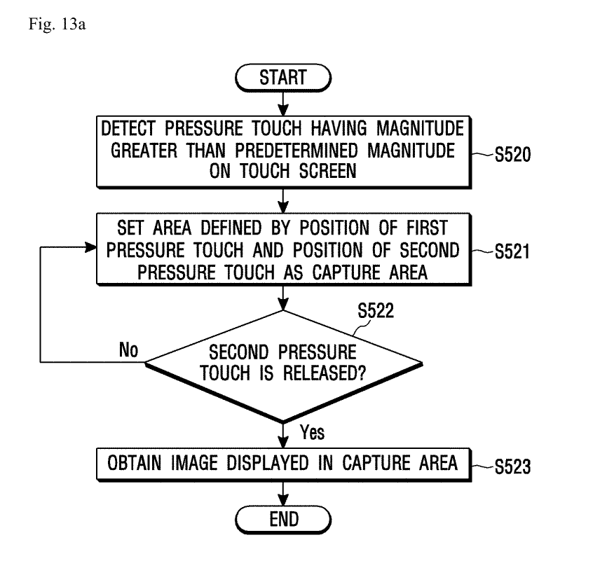

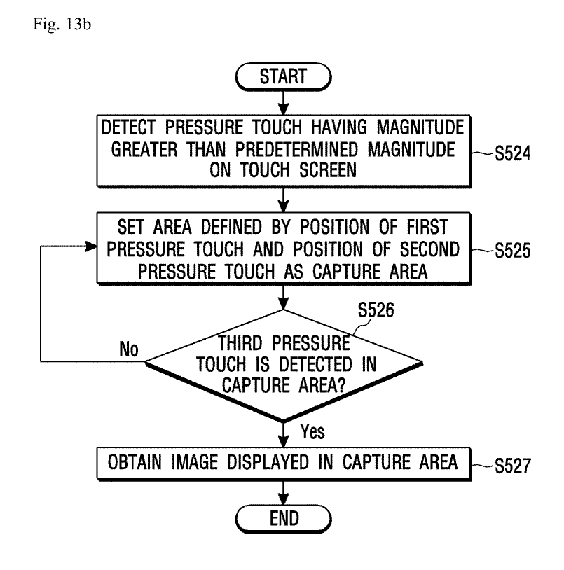

FIGS. 13a and 13b are flowcharts showing the image capturing method according to the embodiment of the present invention and relate to the above-described the second embodiment.

Referring to the flowchart shown in FIG. 13a, in the image capturing method according to the embodiment of the present invention, first, the first 3D touch and the second 3D touch are detected on the touch screen 100 (S520).

As described above, the first 3D touch and the second 3D touch have a pressure having a magnitude greater than a predetermined magnitude, and the positions of the first 3D touch and the second 3D touch on the touch screen 100 are different from each other. Also, the first 3D touch and the second 3D touch may be input sequentially or simultaneously. For example, when the user U sequentially inputs the first 3D touch and then inputs the second 3D touch with one finger (sequential 3D touch), the first 3D touch and the second 3D touch are sequentially detected. When the user U inputs the first 3D touch and the second 3D touch simultaneously with two fingers (multi 3D touch), the first 3D touch and the second 3D touch are detected at the same time. According to the second embodiment, the user U can set the capture area “A” in a manner convenient for the user U himself/herself.

Then, an area defined by the position P1 of the first 3D touch and the position P2 of the second 3D touch is set as the capture area (S521). For example, an area defined by a quadrangle having diagonal vertices of the position P1 of the first 3D touch and the position P2 of the second 3D touch may be set as the capture area “A”. However, as described above, the shape of the capture area “A” is not limited to the quadrangle. Subsequently, when the second 3D touch is released (S522—YES), the image displayed in the capture area “A” is obtained (S523).

Referring to the flowchart shown in FIG. 13b, in the image capturing method according to the embodiment of the present invention, first, the first 3D touch and the second 3D touch which have a pressure having a magnitude greater than a predetermined magnitude and are located in different positions are detected on the touch screen 100 (S524). Then, an area defined by the position P1 of the first 3D touch and the position P2 of the second 3D touch is set as the capture area (S525). An area defined by a quadrangle having diagonal vertices of the position P1 of the first 3D touch and the position P2 of the second 3D touch may be set as the capture area “A”. Finally, if a third 3D touch with a pressure having a predetermined magnitude is detected in the capture area “A” (S526—YES), the image displayed in the set capture area “A” is obtained (S527).

The difference in the flowcharts of FIGS. 13a and 13b is how to obtain the image displayed in the capture area “A”. The image obtainment time of the method shown in FIG. 13a is earlier than that of the method shown in FIG. 13b because the image is obtained only by releasing the second 3D touch. Unlike the method shown in FIG. 13a, the method shown in FIG. 13b is able to allow the capture area “A” to be moved or modified

### Third Embodiment

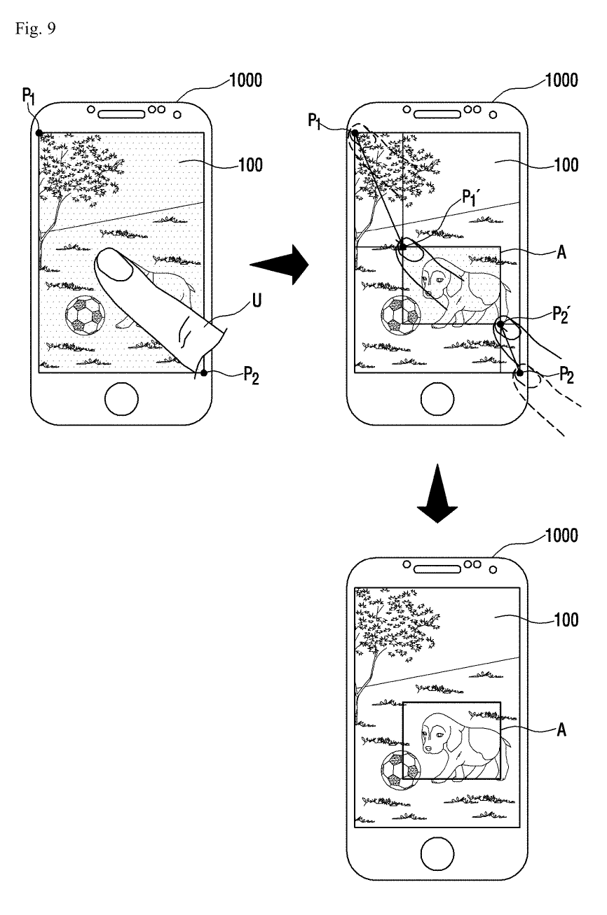

FIG. 9 is a view showing an image capturing method according to a third embodiment in the mobile terminal 1000 according to the present invention.

In order to capture an image, first, the user U may input a 3D touch with a pressure having a magnitude greater than a predetermined magnitude to the touch screen 100. The touch screen 100 detects the 3D touch. When the 3D touch is detected, the control unit 200 displays the entire area of the touch screen 100 as a capture area (indicated by dots in FIG. 9).

In this embodiment, the control unit 200 controls the size and position of the capture area “A” on the basis of the operation of the user U (touch, drag, etc.). In the state where the entire area of the touch screen 100 is displayed as the capture area, the user's touch is input again. The size and position of the capture area “A” are controlled by dragging from a vertex P1 of the top left corner to a desired position P1′ of the touch screen 100 and by dragging from a vertex P2 of the bottom right corner to a desired position P2′ of the touch screen 100. The control unit 200 detects the touch position of the user U and distinguishes the operations (drag, tap, multi-touch, etc.) of the user.

Here, the capture area “A” can be defined by a quadrangle having diagonal vertices of a first drag position P1′ to which the touch has been dragged from the vertex P1 of the top left corner of the entire area of the touch screen 100 and a second drag position P2′ to which the touch has been dragged from the vertex P2 of the bottom right corner of the entire area of the touch screen 100. However, the shape of the capture area “A” is not limited to this, and may be defined by a polygon, a circle, or an ellipse, etc., defined by the first drag position P1′ to which the touch has been dragged from the vertex P1 of the top left corner of the entire area of the touch screen 100 and the second drag position P2′ to which the touch has been dragged from the vertex P2 of the bottom right corner of the entire area of the touch screen 100. According to this, the user U can easily set the capture area “A” by using the 3D touch and the 2D touch.

The control unit 200 may obtain the image displayed in the capture area “A” on the basis of the user's touch (2D or 3D touch) input to the set capture area “A”. However, without such a separate user operation, the image displayed in the capture area “A” can be obtained at the moment the capture area “A” is set by controlling the size and position of the capture area “A”.

Also, the control unit 200 may obtain an image by a multi-touch operation. Specifically, when a separate touch (2D or 3D touch) is detected on the touch screen 100 while a touch (2D or 3D touch) for dragging is input, the control unit 200 can obtain the image displayed in the capture area “A”.

The obtained image may be stored in the memory 300, and the control unit 200 may read the image stored in the memory 300 and display the read image on the touch screen 100.

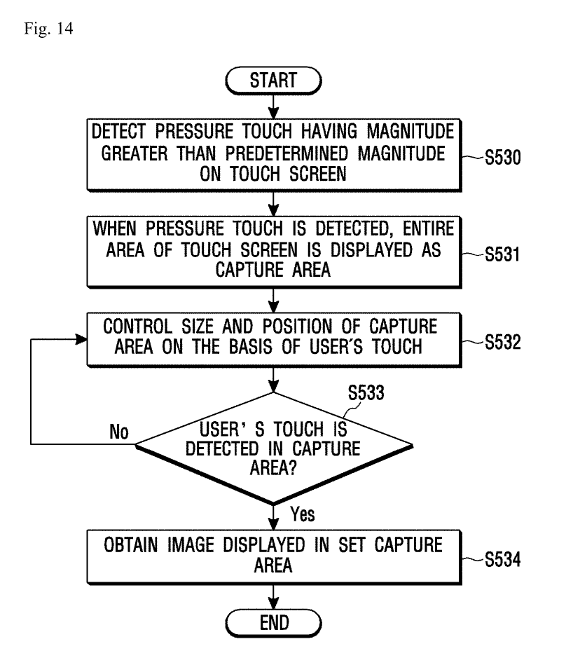

FIG. 14 is a flowchart showing the image capturing method according to the embodiment of the present invention and relates to the above-described the third embodiment.

Referring to the flowchart shown in FIG. 14, in the image capturing method according to the embodiment of the present invention, first, the 3D touch with a pressure having a magnitude greater than a predetermined magnitude is detected on the touch screen 100 (S530). When the 3D touch is detected, the entire area of the touch screen 100 is displayed as the capture area (S531), and the size and position of the capture area are controlled based on the user's touch (S532). When the user's touch (2D or 3D touch) is detected in the controlled capture area “A” (S533—YES), the image displayed in the controlled capture area “A” is obtained (S534).

### Fourth Embodiment

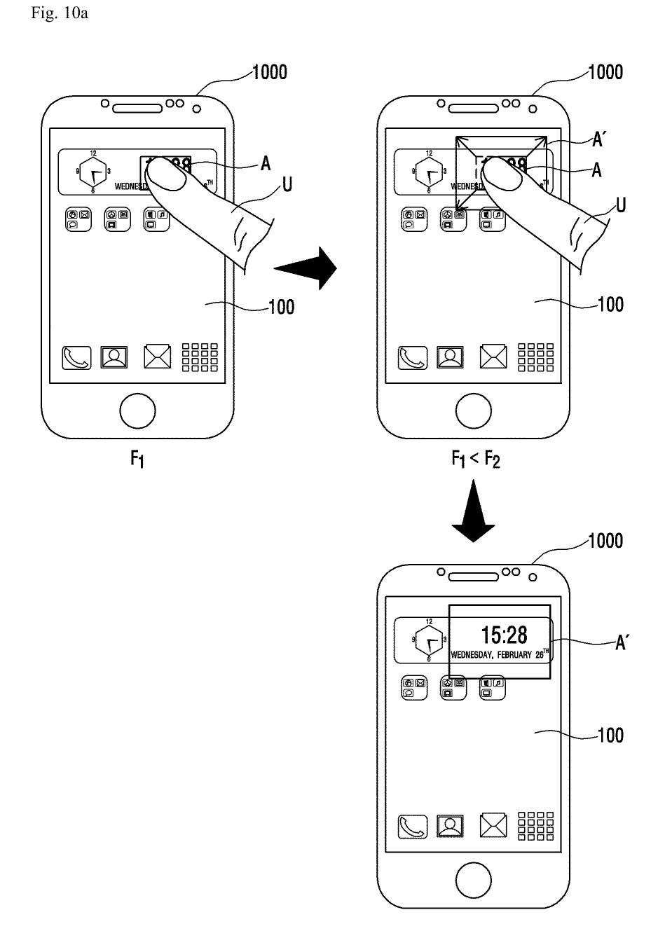

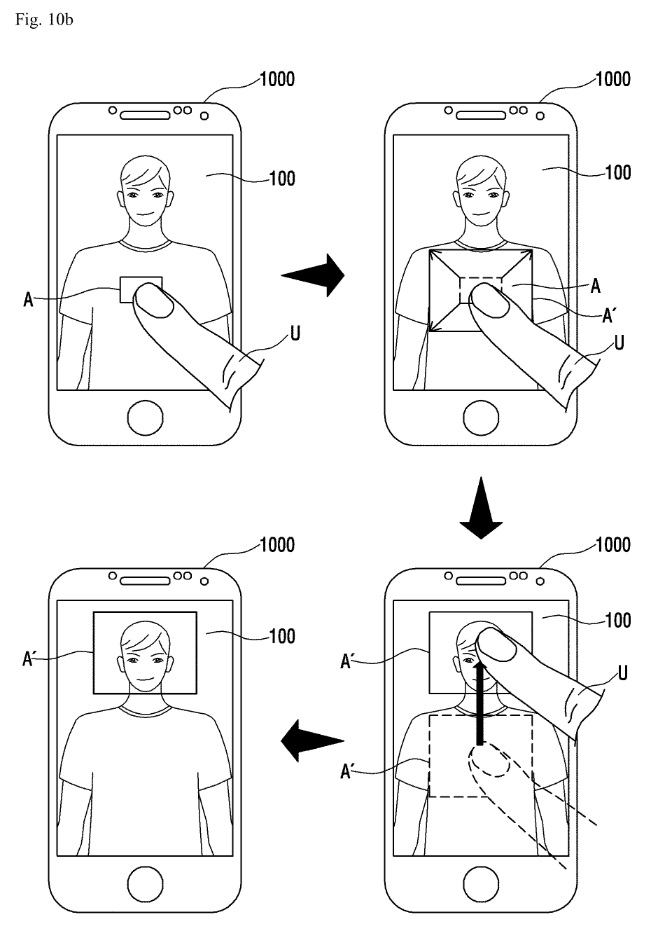

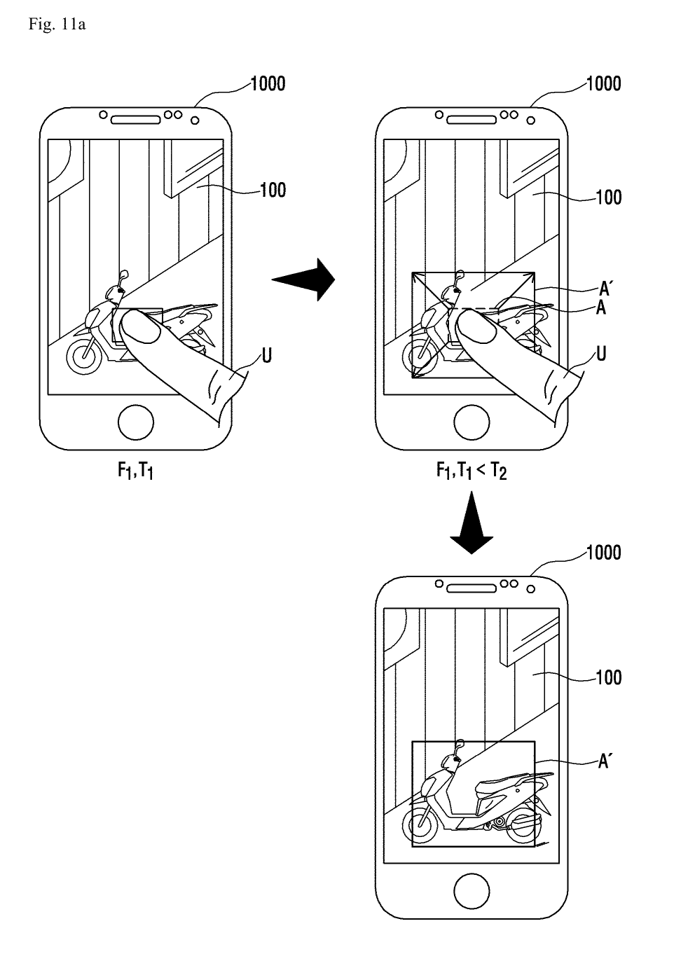

FIGS. 10a and 10b are views showing an image capturing method according to a fourth embodiment in the mobile terminal 1000 according to the present invention.

The touch screen 100 detects a 3D touch with a pressure having a magnitude greater than a predetermined magnitude input from the user U. When the 3D touch is detected, the control unit 200 displays the capture area “A” having a predetermined size on the touch screen 100. In FIGS. 10a and 10b, a capture area “A” made up of a small quadrangle is displayed on the touch screen 100.

The user U can control the size (area) of the capture area “A” in such a manner as to increase or decrease the pressure (force) of the 3D touch.

As shown in FIG. 10a, when the strength of the 3D touch initially input to the touch screen 100 increases from F₁ to F₂ (where F₁>F₂), the control unit 200 enlarges the capture area “A”. The strength of the 3D touch may be measured based on the capacitance change amount as described above. The capture area “A” is enlarged to a capture area “A′” having a larger size (area).

On the contrary, when the strength of the 3D touch decreases from F₂ to F₁, the control unit 200 may reduce the capture area “A”. As such, the user U can easily control the size of the capture area “A” by controlling the magnitude of the pressure (force) of the 3D touch applied to the touch screen 100.

The control unit 200 may obtain the image displayed in the capture area “A′” at a point of time when the 3D touch is released, or at a point of time when the user's touch (2D or 3D touch) is detected again in the capture area “A′”.

Also, the control unit 200 may obtain an image by a multi-touch operation. Specifically, when a separate touch (2D or 3D touch) is detected on the touch screen 100 while the 3D touch for controlling the size of the capture area “A” is applied, the control unit 200 can obtain the image displayed in the capture area “A”.

Meanwhile, as shown in FIG. 10b, in the image capturing method according to the embodiment of the present invention, the position of the capture area “A′” of which the size has been controlled can be moved.

The position control of the capture area “A′” may be, as shown in FIG. 10b, based on the drag operation of the user U. That is, the control unit 200 can move the capture area “A′” to a drag end point when the drag operation of the user U of which the start point is the capture area “A′” is detected. Here, the drag operation of the user may be performed by the 2D touch or the 3D touch. In other words, the drag operation can be performed while applying a predetermined pressure.

The control unit 200 moves the capture area “A′” to the position to which the capture area “A′” is dragged, and then, when the user's touch (2D or 3D touch) is released, the control unit 200 obtains the image displayed in the captured area “A′” of the dragged position. Alternatively, after the capture area “A′” is moved to the position to which the capture area “A′” is dragged, when the user's touch (2D or 3D touch) is detected again in the moved capture area “A′”, the control unit 200 can also obtain the image displayed in the capture area “A′”.

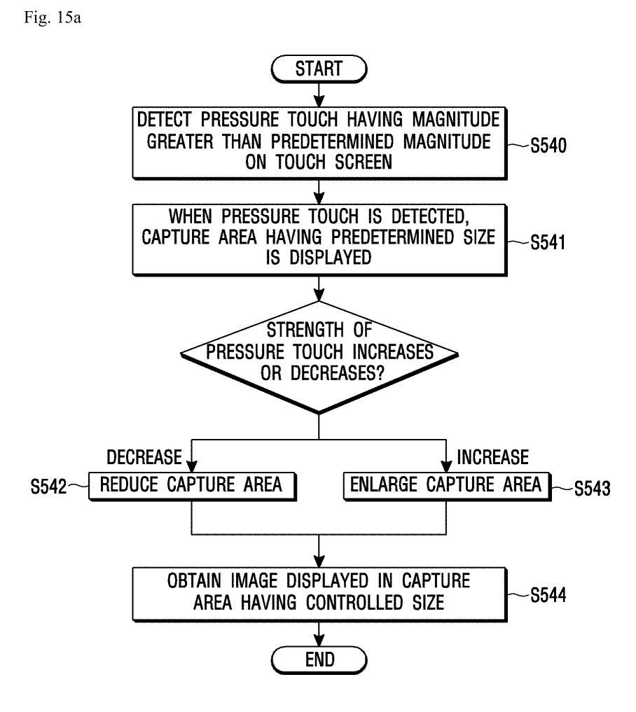

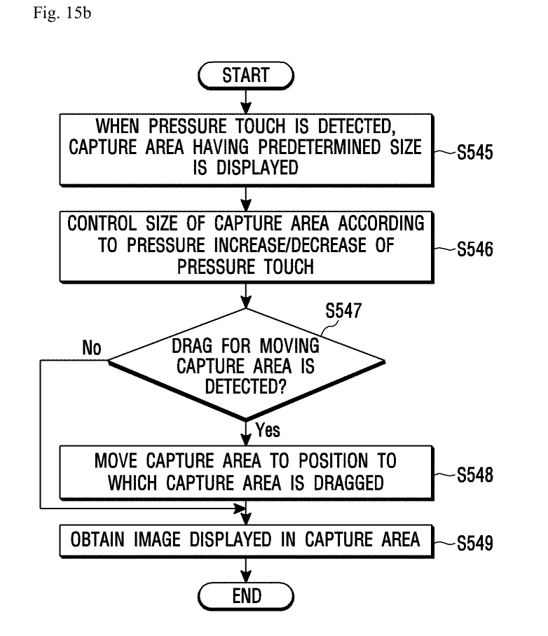

FIGS. 15a and 15b are flowcharts showing the image capturing method according to the embodiment of the present invention and relate to the above-described the fourth embodiment.

Referring to the flowchart shown in FIG. 15a, in the image capturing method according to the embodiment of the present invention, first, the 3D touch with a pressure having a magnitude greater than a predetermined magnitude is detected on the touch screen 100 (S540). When the 3D touch is detected, the capture area having a predetermined size is displayed on the touch screen 100 (S541), and the size of the capture area “A” is enlarged or reduced according to the pressure increase/decrease of the 3D touch. That is, when the strength of the 3D touch decreases, the size of the capture area “A” is reduced (S542), and when the strength of the 3D touch increases, the size of the capture area “A” is increased (S543). When the size of the capture area “A” is controlled, the image displayed in the captured area “A′” having the controlled size is obtained (S544).

Referring to the flowchart shown in FIG. 15b, in the image capturing method according to the embodiment of the present invention, first, when the 3D touch is detected, the capture area “A” having a predetermined size is displayed (S545), and the size of the capture area “A” is controlled according to the pressure increase/decrease of the 3D touch in the above-described manner (S546). Subsequently, if no drag for moving the capture area is detected (S547—NO), the control unit 200 obtains the image displayed in the capture area “A′” of which only the size has been controlled (S549). Alternatively, if drag for moving the capture area “A′” is detected (S547—YES), the control unit 200 moves the capture area “A′” to the position to which the capture area “A′” is dragged (S548), and obtains the image displayed in the moved capture area “A′” (S549).

### Fifth Embodiment

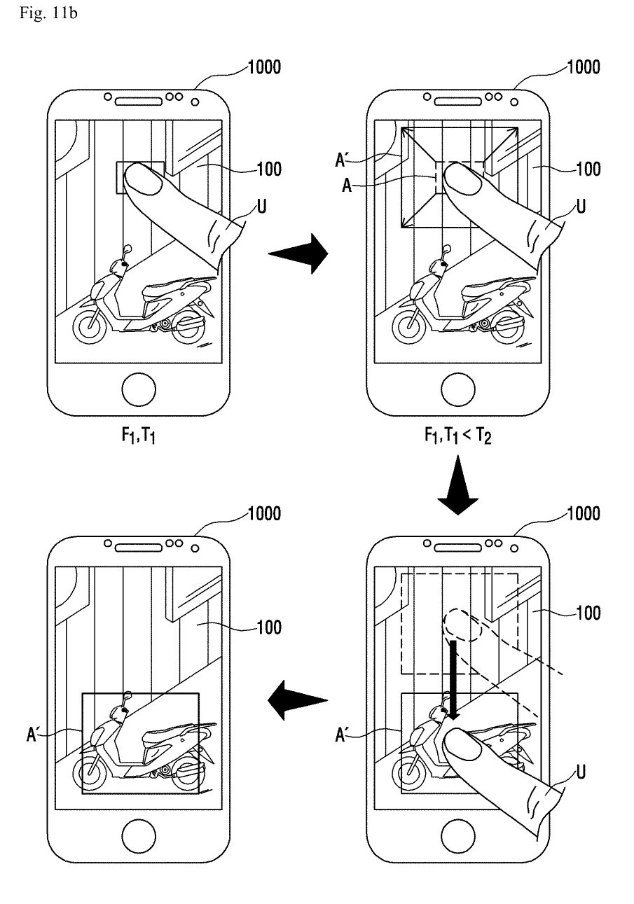

FIGS. 11a and 11b are views showing an image capturing method according to a fifth embodiment in the mobile terminal 1000 according to the present invention.

The touch screen 100 detects a 3D touch with a pressure having a magnitude greater than a predetermined magnitude input from the user U. When the 3D touch is detected, the control unit 200 displays the capture area “A” having a predetermined size on the touch screen 100. In FIGS. 11a and 11b, a capture area “A” made up of a small quadrangle is displayed on the touch screen 100. The control unit 200 enlarges the size of the capture area “A” in proportion to the duration time of the 3D touch, and the duration time of the 3D touch may be measured by means of the timer 450, etc.

As shown in FIG. 11a, when the 3D touch with a pressure F₁ having a magnitude greater than a predetermined magnitude continues for a predetermined time T₁, the control unit 200 can enlarge the capture area “A”. Here, the enlargement of the capture area “A” may be proportional to the duration time T₁ to T₂.

In other words, when the 3D touch continues from T₁ to T₂, the control unit 200 enlarges the capture area “A” in response to the duration time (T₂−T₁) of the 3D touch. The enlargement ratio of the capture area “A” according to the duration time may be set in advance. The user U controls the duration time of the 3D touch input to the touch screen 100, that is to say, controls a point of time of releasing the 3D touch, thereby easily controlling the size of the capture area “A”.

When the size of the capture area “A′” is controlled, the control unit 200 may obtain the image displayed in the capture area “A′” at a point of the time when the 3D touch is released. Alternatively, the control unit 200 may also obtain the image displayed in the capture area “A′” when a user's touch (2D or 3D touch) is detected in the controlled capture area “A′”.

Also, the control unit 200 may obtain an image by a multi-touch operation. Specifically, when a separate touch (2D or 3D touch) is detected on the touch screen 100 while the touch (2D or 3D touch) for controlling the size of the capture area “A′” is input, the control unit 200 can obtain the image displayed in the capture area “A′”.

Meanwhile, as shown in FIG. 11b, the user U can move the position of the capture area “A′” of which the size has been controlled. When the drag operation of the user U of which the start point is the size-controlled capture area “A′”, the control unit 200 can move the capture area “A′” to a drag end point. The drag operation of the user U may be performed by the 2D touch or by the 3D touch. That is, the drag operation can be performed while maintaining a predetermined pressure.

The control unit 200 moves the capture area “A′” to the position to which the capture area “A′” is dragged, and then, at the moment when the user's touch (2D or 3D touch) is released, the control unit 200 obtains the image displayed in the captured area “A′”.

The control unit 200 moves the capture area “A′” to the dragged position and obtains the image displayed in the capture area “A′” at the moment when the user's touch (2D or 3D touch) is released. However, the embodiment of the present invention is not limited to this. When the user's touch (2D or 3D touch) is detected in the capture area “A′”, the control unit 200 can also obtain the image displayed in the capture area “A′”.

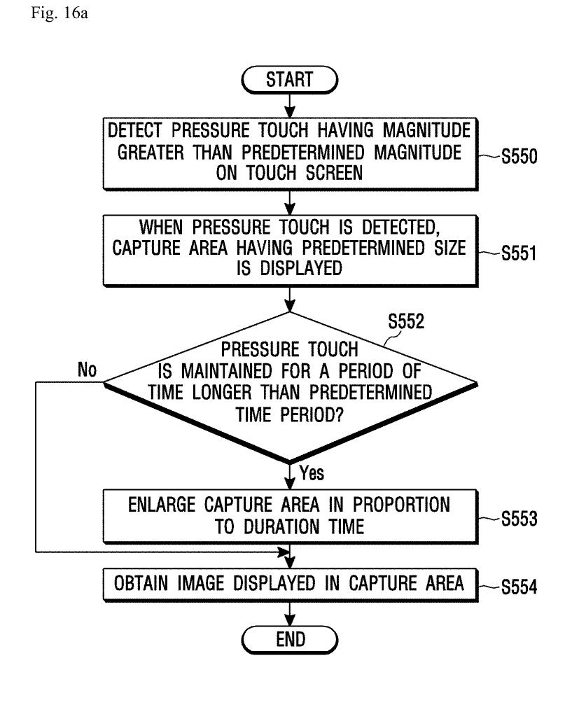

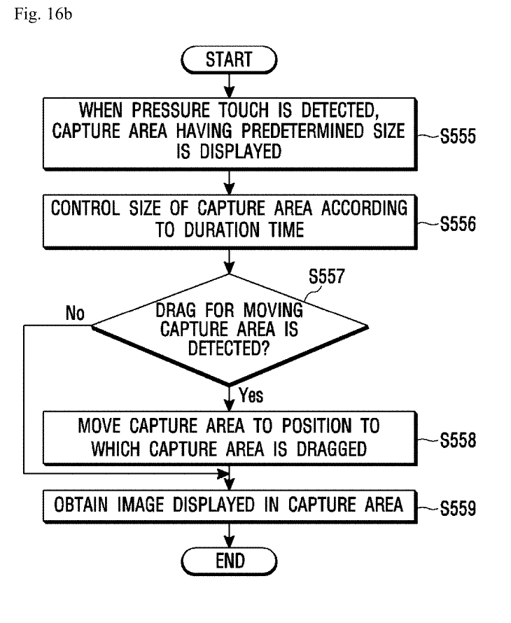

FIGS. 16a and 16b are flowcharts showing the image capturing method according to the embodiment of the present invention and relate to the above-described the fifth embodiment.

Referring to the flowchart shown in FIG. 16a, in the image capturing method according to the embodiment of the present invention, first, the 3D touch with a pressure having a magnitude greater than a predetermined magnitude is detected on the touch screen 100 (S550). When the 3D touch is detected, the capture area having a predetermined size is displayed on the touch screen 100 (S551). If the 3D touch is maintained for a period of time longer than a predetermined time period (S552—YES), the size of the capture area “A” is increased in proportion to the duration time of the 3D touch (S553). Finally, the image displayed in the capture area “A′” is obtained (S554).

Referring to the flowchart shown in FIG. 16b, in the image capturing method according to the embodiment of the present invention, first, when the 3D touch is detected, the capture area “A” having a predetermined size is displayed (S555), and the size of the capture area “A” is controlled in proportion to the duration time of the 3D touch in the above-described manner (S546). Subsequently, if no drag for moving the capture area “A′” is detected (S557—NO), the control unit 200 obtains the image displayed in the capture area “A′” (S557). Alternatively, if drag for moving the capture area is detected (S557—YES), the control unit 200 moves the capture area “A′” to the position to which the capture area “A′” is dragged (S558), and obtains the image displayed in the moved capture area “A′” (S559).

In the above description, the release of the 3D touch may mean that the touch between the object (the user's finger, etc.) and the touch screen 100 is released. However, the embodiment of the present invention is not limited to this. The release of the 3D touch may also mean that when the strength of the 3D touch is reduced to less than a predetermined magnitude while the touch (the user's finger, etc.) between the object and the touch screen 100 is maintained, the touch is switched to the 2D touch.

The features, structures and effects and the like described in the embodiments are included in at least one embodiment of the present invention and are not necessarily limited to one embodiment. Furthermore, the features, structures, effects and the like provided in each embodiment can be combined, changed, modified, converted, replaced, added, transformed, and applied by those skilled in the art to which the embodiments belong. Therefore, contents related to the combination, change, modification, conversion, replacement, and addition should be construed to be included in the scope of the present invention without departing from the spirit of the present invention.

### INDUSTRIAL APPLICABILITY

According to the mobile terminal and image capturing method according to the embodiment of the present invention, it is possible to easily capture in various ways images displayed on the mobile terminal.

1. An image capturing method comprising:
detecting a pressure touch with a pressure having a magnitude greater than a predetermined magnitude on a touch screen;
determining an initial touch position and a final touch position of the pressure touch;
setting an area defined by the initial touch position and the final touch position as a capture area; and
obtaining an image displayed in the capture area.

2. The image capturing method of claim 1, wherein, in the obtaining, when the pressure touch is released, the image displayed in the capture area is obtained.

3. The image capturing method of claim 1, wherein, in the obtaining, when the pressure touch with a pressure having a magnitude greater than a predetermined magnitude is detected within the capture area after the pressure touch is released, or alternatively when a separate touch is detected on the touch screen while the pressure touch is applied, the image displayed in the capture area is obtained.

4. The image capturing method of claim 1, wherein the final touch position is a position to which a drag operation is performed from the initial touch position, in a state where the pressure having a magnitude greater than a predetermined magnitude is maintained.

5. The image capturing method of claim 1, wherein the final touch position is a position to which a drag operation is performed from the initial touch position, in a state where the pressure having a magnitude greater than a predetermined magnitude is not maintained.

6. The image capturing method of claim 1, wherein, in the setting, an area defined by a quadrangle having diagonal vertices of the initial touch position and the final touch position is set as the capture area.

7. An image capturing method comprising:
detecting, on a touch screen, a first pressure touch and a second pressure touch which have a pressure having a magnitude greater than a predetermined magnitude and are located in different positions;
setting an area defined by a position of the first pressure touch and a position of the second pressure touch as a capture area; and
obtaining an image displayed in the capture area.

8. The image capturing method of claim 7, wherein, in the obtaining, when the second pressure touch is released, the image displayed in the capture area is obtained.

9. The image capturing method of claim 7, wherein, in the obtaining, when a third pressure touch with a pressure having a magnitude greater than a predetermined magnitude is detected within the capture area after the second pressure touch is released, or alternatively when a separate touch is detected on the touch screen while the second pressure touch is applied, the image displayed in the capture area is obtained.

10. The image capturing method of claim 7, wherein, in the setting, an area defined by a quadrangle having diagonal vertices of the position of the first pressure touch and the position of the second pressure touch is set as the capture area.

11. An image capturing method comprising:
detecting a pressure touch with a pressure having a magnitude greater than a predetermined magnitude on a touch screen;
displaying an entire area of the touch screen as a capture area when the pressure touch is detected;
controlling a size and a position of the capture area on the basis of a user's touch; and
obtaining an image displayed in the controlled capture area.

12. The image capturing method of claim 11, wherein, in the controlling, the size and position of the capture area is controlled by an area defined by a quadrangle having diagonal vertices of a first drag position to which the touch has been dragged from the vertex of the entire area of the touch screen and a second drag position to which the touch has been dragged from the vertex of the entire area of the touch screen.

13. The image capturing method of claim 11, wherein, in the obtaining, when the pressure having a magnitude greater than a predetermined magnitude is detected within the controlled capture area, the image displayed in the capture area is obtained.

14-19. (canceled)

20. A mobile terminal comprising:
a touch screen which detects a pressure touch with a pressure having a magnitude greater than a predetermined magnitude;
a control unit which sets an area defined by an initial touch position and a final touch position of the pressure touch as a capture area, and obtains an image displayed in the set capture area; and
a memory which stores the obtained image.

21. The mobile terminal of claim 20, wherein, when the pressure touch is released, the control unit obtains the image displayed in the capture area.

22. The mobile terminal of claim 20, wherein, when the pressure touch with a pressure having a magnitude greater than a predetermined magnitude is detected within the capture area after the pressure touch is released, or alternatively when a separate touch is detected on the touch screen while the pressure touch is applied, the control unit obtains the image displayed in the capture area.

23. The mobile terminal of claim 20, wherein the final touch position is a position to which a drag operation is performed from the initial touch position, in a state where the pressure having a magnitude greater than a predetermined magnitude is maintained.

24. The mobile terminal of claim 20, wherein the final touch position is a position to which a drag operation is performed from the initial touch position, in a state where the pressure having a magnitude greater than a predetermined magnitude is not maintained.

25. The mobile terminal of claim 20, wherein the control unit sets an area defined by a quadrangle having diagonal vertices of the initial touch position and the final touch position as the capture area.

26. A mobile terminal comprising:
a touch screen which detects a first pressure touch and a second pressure touch which have a pressure having a magnitude greater than a predetermined magnitude;
a control unit which sets an area defined by the first pressure touch and the second pressure touch which are located in different positions as a capture area, and obtains an image displayed in the set capture area; and
a memory which stores the obtained image.

27. The mobile terminal of claim 26, wherein, when the second pressure touch is released, the control unit obtains the image displayed in the capture area.

28. The mobile terminal of claim 26, wherein, when a third pressure touch with a pressure having a magnitude greater than a predetermined magnitude is detected within the capture area after the second pressure touch is released, or alternatively when a separate touch is detected on the touch screen while the second pressure touch is applied, the control unit obtains the image displayed in the capture area.

29. The mobile terminal of claim 26, wherein the control unit sets an area defined by a quadrangle having diagonal vertices of the position of the first pressure touch and the position of the second pressure touch as the capture area.

30. A mobile terminal comprising:
a touch screen which detects a pressure touch with a pressure having a magnitude greater than a predetermined magnitude;
a control unit which displays an entire area of the touch screen as a capture area when the pressure touch is detected, controls a size and a position of the capture area on the basis of a user's touch, and then obtains an image displayed in the controlled capture area; and
a memory which stores the obtained image.

31. The mobile terminal of claim 30, wherein the control unit controls the size and position of the capture area by an area defined by a quadrangle having diagonal vertices of a first drag position to which the touch has been dragged from the vertex of the entire area of the touch screen and a second drag position to which the touch has been dragged from the vertex of the entire area of the touch screen.

32. The mobile terminal of claim 31, wherein, when the pressure having a magnitude greater than a predetermined magnitude is detected within the controlled capture area, the control unit obtains the image displayed in the capture area.

33-38. (canceled)
